(19) United States
(12) Patent Application Publication
(10) Pub. No.: US 2024/0028887 A1
(43) Pub. Date: Jan. 25, 2024

(54) Processing Using a Neural Network and a Similarity Metric

(71) Applicant: RapidSilicon US, Inc, Los Gatos, CA (US)

(72) Inventor: Valerio Tenace, Torino (IT)

(21) Appl. No.: 18/073,400

(22) Filed: Dec. 1, 2022

Related U.S. Application Data
(60) Provisional application No. 63/390,397, filed on Jul. 19, 2022.

(51) Int. Cl. G06N 3/08

(52) U.S. Cl. CPC G06N 3/08

(57) ABSTRACT

A technology is described for classification using a convolutional-inspired neural network. The method can include the operation of receiving an input feature map to an input layer of the convolutional neural network. Another operation may be applying a convolutional layer using an operator and a filter to form an output feature map. The operator may include a similarity metric that provides a similarity output between a filter tensor from the filter and a feature tensor from the input feature map. The output feature map may then be flattened. A further operation may be defining a class of the output feature map using a fully connected output layer.

Priority is claimed to Provisional Patent Application Ser. No. 63/390,397 filed on Jul. 19, 2022, entitled PROCESSING USING A NEURAL NETWORK AND A SIMILARITY METRIC which is incorporated by reference in its entirety herein.

### BACKGROUND

In Von Neumann computing architectures, logic processors and memory banks are two separate entities figuratively connected by a bi-directional stream of data. Since processors' frequencies have significantly increased over the past years, idle times due to memory synchronization can represent a huge portion of the overall latency in computing. As such a difference in performance between logic processors and memory widens, the memory wall problem that is intrinsic to Von Neumann architectures may become a serious bottleneck.

As a result, the cost to sustain data-intensive applications is heavily impacted by an adverse energy vs. delay ratio, which leads to comparatively poor computational efficiency for data-intensive applications. Convolutional Neural Networks (hereinafter “ConvNets”) are a form of machine learning that may exacerbate this problem, as they easily reach tens of millions of parameters, and result in a memory footprint on the order of tens of megabytes that perform billions of operations per second to achieve acceptable performance speed. This memory wall or memory latency problem is even more significant when such processing occurs in edge applications, where accessing available memory banks may be restricted by a limited power budget. Not to mention that most ConvNets may not even fit inside such a limited volatile memory space provided by edge devices or edge applications.

### BRIEF DESCRIPTION OF THE DRAWINGS

FIG. 1A is a diagram illustrating an example bar graph describing the total number of off-chip accesses required for the VGG-16 CNN (Convolutional Neural Network model as trained on ImageNet.

FIG. 1B is a diagram illustrating an example bar graph where the total number of DRAM accesses (321M) and the total number of 32-bit Multiply-and-Accumulate (MAC) operations (around 15.5G) are weighted based on their associated energy measurements.

FIG. 2 is an example block diagram illustrating the structure of a ConvNet (“Convolutional Neural Network”) composed of multiple layers.

FIG. 3 is a flow diagram with blocks illustrating an example in section (a) of a SLIM block with SLIM layers interleaved with batch normalization layers; and (b) illustrating an example of an overall architecture of the SLIM-Net model.

FIG. 4 is a table illustrating an example of compared results from ConvNets and the present technology.

FIG. 5 is flowchart illustrating an example of a method of classification using a convolutional-inspired neural network.

FIG. 6 illustrates a computing device which may execute this technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Convolutional Neural Networks (ConvNets) are now considered an important technique in many digital image processing applications and similar classification applications. Since ConvNets are composed of millions of parameters that spread over rather deep chains of diverse feature extraction layers, ConvNets have achieved super-human performance in several image classification and segmentation tasks. However, such an impressive breakthrough comes at a high price in terms of hardware efficiency. In particular, a typical ConvNet with tens of millions of parameters implies frequent and substantial data transfers to and from external memory banks, i.e., DRAMs, in order to fetch input data, and also to store or retrieve intermediate results that are needed to complete a single forward pass. Needless to say, this scenario may exacerbate the memory-wall problem, which is intrinsic to any Von Neumann type architecture.

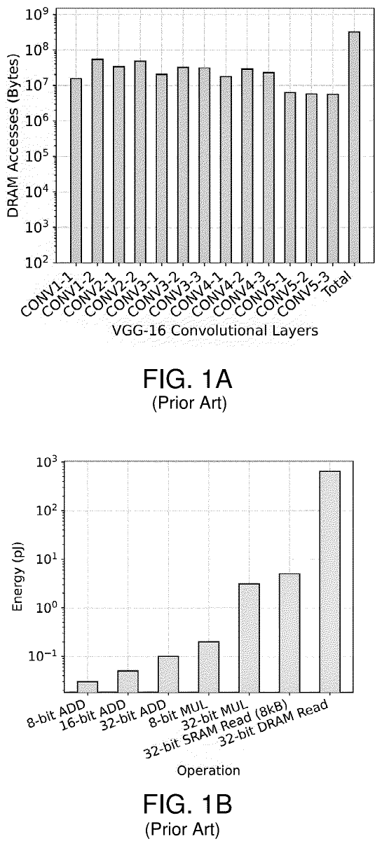

In one example, SRAMs (Static Random-Access Memory), which are typically a faster, smaller (on the order of kilobytes (kB)) and more power-aware memory, have been adopted in several near-memory accelerators, but such SRAMs have physical sizes that can just accommodate ConvNet models of the smallest sizes, which are tuned for rather simple tasks. However, when the target application requires a high precision, or when complex inputs need to be processed, then DRAM-size memories are the preferred technology. Unfortunately, DRAM memories are usually power-hungry modules that use complex interfaces (and non-negligible in terms of area and power consumption) to achieve the desired functionality. For these reasons, many previous systems have adopted hardware architectures that employ a hierarchical memory organization. At the lowest level, where efficiency is key, systems may use register files that are used to store and retrieve intermediate results produced by individual processing elements (PEs). This combination may be achieved by coupling an SRAM memory with a specialized computational unit, in order to establish a Single Instruction Multiple Data (SIMD) computational paradigm. In other words, these components may be power-efficient, small scratchpad memories with nearby computational capabilities. The intermediate and the highest levels of the hierarchy may be occupied by global buffers and off-chip DRAMs, respectively. The latter, as mentioned earlier, represents the biggest source of concern for a sustainable deployment of ConvNets to resource-constrained devices. Consider, for instance, the plot reported in FIG. 1A, which describes the total number of off-chip accesses required for VGG-16, trained on ImageNet, using the Eyeriss accelerator. ImageNet is an image database organized according to a lexical database word hierarchy (currently only the nouns), in which each node of the hierarchy is depicted by hundreds and thousands of images. Eyeriss is an energy-efficient deep convolutional neural network (CNN) accelerator that supports state-of-the-art CNNs, which have many layers, millions of filter weights, and varying shapes (filter sizes, number of filters and channels). If the total number of DRAM accesses (321M) and the total number of 32-bit Multiply-and-Accumulate (MAC) operations (around 15.5G) are weighted based on their associated energy measurements reported in FIG. 1B, then the DRAM alone accounts for 81% of the combined energy.

The present technology relates to an improvement for supervised machine learning (e.g., classification or regression) using convolutional-inspired neural networks. In particular, this technology describes a convolutional-inspired neural network layer that leverages similarity metrics when applying a convolution kernel (e.g., associating kernel weights and sample inputs).

Some previous technologies have tried to reduce the size of ConvNet model architectures to fit the requirements of resource-constrained devices. However, the present technology has identified convolution layers with built-in functionalities that can provide more powerful feature extraction capabilities while, at the same time, reducing the overall memory footprint of the ConvNet model.

This technology provides what can be called a SLIM-Net. This layer is a ConvNet-inspired architecture that leverages Similarity Metric (SLIM)-aware layers. These layers represent a method for correlating input tensors to learnable weights, thus conveying enhanced expressiveness into the forward pass computations, directly translating into fewer parameters but effective predictive performances. Experimental results, conducted on the open-source CIFAR-10 and CIFAR-100 datasets, demonstrate that SLIM-Net is able to match, if not sometimes exceed, the accuracy of other previous models, like MobileNetV1 and ResNet-50, while having a model structure that is around 2X and 12X smaller in size, respectively.

Being able to reduce ConvNet model sizes solves an important problem that, where resolved, can potentially enable smarter and more efficient hardware deployment techniques that may otherwise be impractical. Balancing the relationship between DRAM accesses and arithmetic operations can improve near-memory hardware architectures, e.g., maximizing the information extracted at the PE (processing element) level can certainly increase the computational complexity. At the same time, more meaningful parameters may also enable a more compact neural network model.

This technology provides a convolutional-like layer that uses a similarity metric or a similarity metric operator in a convolutional style layer, where typical MAC operations are replaced with a selected Similarity Metric, hence the name SLIM. This approach has at least two aspects: (1) a similarity metric establishes a clear and meaningful correlation between input tensors and learnable weights, thus conveying enhanced expressive capabilities to feature extraction layers; and (2) such a gain in terms of expressive power directly translates into fewer parameters, thus enabling the creation of compact and efficient models.

This technology may use a similarity metric in a SLIM layer used as a filter where previously used MACs are replaced with a tensor-weights correlation function. The use of some additional computational complexity (due to the similarity metric) provides a more compact layer-wise representation in return. This configuration not only delivers smaller model sizes, but it also improves the information-per-operation ratio, thus maximizing feature extraction at the PE level.

A SLIM Block can be used, which is a plurality of deep learning layers, combined with the SLIM layer. A SLIM Block can serve as a primitive in designing additional architectures, since the SLIM block can be easily replicated to achieve deeper SLIM-Net models. The overall architecture of a SLIM-Net implementation with its performance and compactness as compared to other previous ConvNet models will be discussed later.

This technology may be considered to be at the intersection between model compression and computation enhancement. Some model compression techniques may revolve around quantization techniques. Quantization can reduce the complexity of the calculations that a computing device performs when obtaining a prediction about a question or a prediction about images. Aggressive quantization may be used where optimal parameter representations are obtained via arithmetic precision fine-tuning. Quantization can quantize weights to zero, or powers of two, by minimizing the Euclidean distance between full-precision weights and quantized weights. Applied at training time, quantization can reduce 32-bit floating-point weights to 6-bit, thus achieving a remarkable memory compression, without affecting the yields of, for example, the ResNet-50 model. Even more extreme techniques include the possibility to quantize weights to the binary or the ternary domains. Although such solutions drastically reduce both the computation workload and memory requirements, they can sometimes lead to critical accuracy losses when evaluated on large and complex datasets. Overall, quantization can be used for model compression, especially since 6-bit and 8-bit weight quantization schemes usually do not affect the overall predictive performances of ConvNets. Furthermore, the present technology and quantization may be used together, in order to achieve even more compact models.

The main source of power consumption in a ConvNet or CNN (Convolutional Neural Network) is memory and quantization is helpful in reducing memory use and memory accesses because quantization provides a compact representation of the parameters (e.g., weights). Memory may accounting for 80%-90% of the energy used in processing a ConvNet. An increased number of parameters can be sent in a data transfer batch with reduced precision, as compared to un-quantized parameters. By compressing the parameter data using: reduced precision, truncation or similar quantization schemes, an increased number of data elements may be in each of the data transfer batches. The trade-off is that some information or accuracy may be lost but the information can be compressed. For example, truncation may take a 32-bit number representation and project the value to a reduced storage size. Accordingly, a reduced number of data transfer batches may be transferred. Reducing the size of the parameters can ultimately reduce the amount of energy and time used for data transfers.

Computation enhancement techniques usually fall under the umbrella of improved predictive and generalization performances. For example, in the past some ConvNets have used an inner-product formulation and a dedicated activation function that, when combined together, are able to improve the level of abstraction of a typical ConvNet. However, this inner-product configuration implies specific initialization (pre-training) techniques for weight matrices, as well as extremely complex arithmetic operations employed in the proposed inner-product formula. Other prior work has focused on a dedicated inner-product definition, but with the objective of improving the generalization capabilities of ConvNets. Also in this type of case, however, weights initialization plays a fundamental role and model sizes may not be optimal. The inherently different implementations of the inner-product formulations, combined with the strict boundary conditions that have to be met (e.g., weights initialized with specific algorithms, thus requiring ad hoc training procedures) represent the main differentiator factors that do not provide results as valuable as the present technology.

The present technology can be used to balance the ratio between the energy budget for RAM accesses and the energy budget for arithmetic calculations. In the present technology, the calculation has been made more complex in order to enable less access to RAM. Since there is a significant difference in the power consumed by data transfer and processing related to applying the filter, the present technology increases the complexity of power consumption of the arithmetic part to reduce the overall DRAM accesses. The present technology also uses an operation which uses fewer parameters by design. These results are completely decoupled from any quantization or compression techniques but quantization or parameter compression techniques can still be applied to this technology.

A simple prior ConvNet model can be composed of two convolutional layers and two pooling layers for the feature extraction. Classification layers or output layers are represented with a series of three fully connected layers, where the last fully connected layer produces class- or label-wise probabilities.

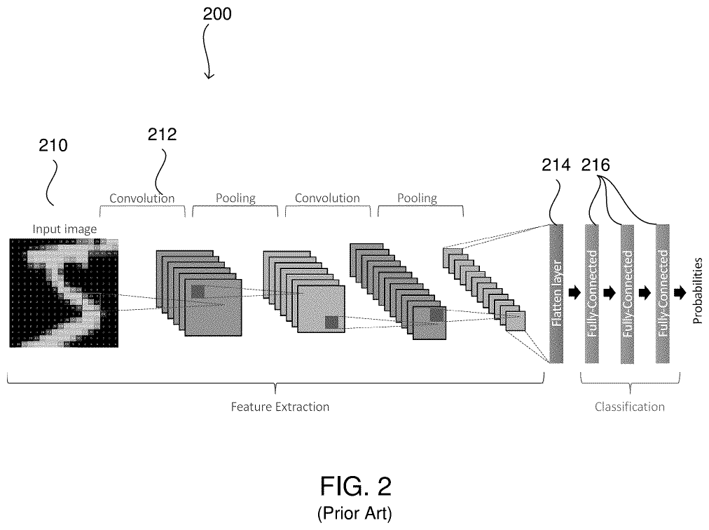

FIG. 2 depicts an example of the structure of a ConvNet 200 composed of multiple layers, each with a proper function: an input layer 210 that handles the source image for computational stages, a flattening layer 214, a series of output layers 216 that are in charge of producing the final classification, and several hidden layers 212 (e.g., convolution and pooling) where the feature extraction takes place. Hidden layers are composed of a cascade of different types of layers. A later discussion will describe the improved convolutional style layers of the present technology.

Convolutional layers

Convolutional layers represent the centerpiece of any ConvNet. Primarily designed for feature extraction, any given convolutional layer performs a piece-wise linear transformation between an input feature map (i.e., the input image, in the case of the first convolutional layer, or the results generated by some other upstream layer, when we consider any convolutional layer after the first one) and the coefficients of multiple learnable filters that are iteratively adjusted during the training phase. Given input feature map, represented with a tensor I=R^{w×h×c}, is fed to a convolutional layer having filters W∈R^{f×k×k×c}, where the i-th component Kᵢ∈R^{k×k} denotes a single kernel of the j-th filter Wⱼ, with 0≤j≤f. Note that w, h, c, k and f are each defined in R and that they indicate the width, height, and channels of the input feature map, the dimensions of the kernel component, and the total number of filters, respectively. Given that w, h<<k, a convolution operation consists in sliding, or convolving, a generic filter Wⱼ across the width and the height of the input feature map, producing a 2-dimensional output feature map. The fundamental piece-wise operation carried out at each step is given in Equation 1, where I^{▭, α} represents a squared slice along the height and the width of the input feature map along the α∈c axis, B∈R^{k×f} represents the bias terms for each kernel K and the symbol ⊗ indicates the dot product between the two tensors.

Λ=Σ_{α∈c}I^{▭,α}⊗W_{β}^{α}+B_{β}^{α}∀β∈ƒ Equation (1)

Given a stride S∈N denoting the step at which the sliding filter is applied, the channel-wise output of the convolutional layer generates a 2-dimensional output feature map having size given in Equation (2), with p representing the zero padding applied to I. Equation 2 holds true iff h=w, i.e., the input feature map has a squared shape along its height and width.

$$Θ = \frac{w - k + 2 p}{S} + 1 \qquad Equation ( 2 )$$

As mentioned above, a convolutional layer performs a linear transformation of the input feature map. The non-linearity (i.e., the cornerstone of any deep neural network model) is delegated to activation layers, which are usually coupled to the output of any convolutional stage in a ConvNet.

Activation layers

These layers apply a transformation function φ(·): R→R. Being cascaded to convolutional layers, they operate element-wise on their own input feature maps. Several types of activation functions exist, but usually deciding which one is likely to work better for a specific problem boils down to a trial-and-error phase, where the neural network under test is empirically evaluated on a given dataset. Despite Tanh, Sigmoid, and ReLU generally being considered the most popular activation functions in modern ConvNet models, the process of selecting the optimal activation function still remains a non-trivial, time-consuming task.

### The SLIM Layer

By resorting to the same notation introduced earlier, one possible formulation of the similarity metric is illustrated in Equation (3), where the operator ∥·∥² represents the I²-norm of the tensor.

$${Λ}^{SLIM} = {\sum }_{a ∈ c} \frac{{I}^{□ , α} O * {W}_{β}^{α}}{{‖ 1 {I}^{□ , α} ‖}^{2} + {‖ {W}_{β}^{α} ‖}^{2} - {I}^{□ , α} O * {W}_{β}^{α}} + {B}_{β}^{α} ∀ β ∈ f \qquad Equation ( 3 )$$

The similarity metric operator in Equation 3 is more expressive than a MAC operator used in prior ConvNets, and this is due to computing a distance or similarity between two tensors. In addition, the similarity metric provides an activation output. This similarity metric contains what has previously been two stages in other models, namely the convolution operator and the activation operator. The similarity metric operation also provides more information using the distance or similarity operation and results in smaller neural network structures.

By leveraging such a similarity metric between tensors ID▭,α and w_{β}^{α}, this mechanism constitutes the basic building block of the SLIM layer. The similarity metric represents an improvement between prior convolutional layers, as discussed earlier, and this technology. This means that, without loss of generality, any given convolutional layer can be transformed into a SLIM layer by modifying Equation 1 with Equation 3. This not only preserves the features of prior convolutional layers (e.g., leveraging a local receptive field, executing spatial sub-sampling, and allowing parameters sharing) but it also works as an expressive and more meaningful activation function, since the operator with the similarity metric can be seen as a way to “bind” network parameters to input samples, thus molding the weights of the model to the input images.

The similarity metric may determine a distance metric between the filter and the input feature map. In addition, the similarity metric can produce an output which approximates an activation function. Examples of a similarity metric may be at least one of: an L-2 norm of the input feature map and the filter tensor, a modulo squared of the feature tensor and filter tensor that determines a distance metric between the feature tensor and the filter tensor defined between l-1, +11, a Cosine similarity, an Arccosine similarity, the similarity metric of Equation 3 in this disclosure, or a similarity metric computable between n-dimensional tensors. Furthermore, any similarity metric can be used as the operator which provides a similarity measure or distance measure and a non-linear output (e.g., similar to an activation function).

### The SLIM Block

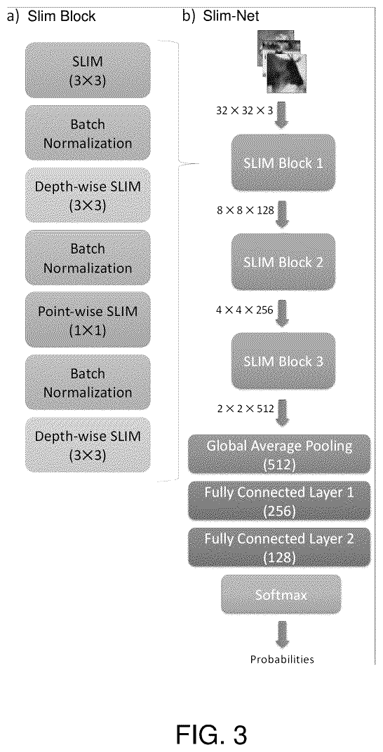

Similar to any other layer in a ConvNet, the proposed SLIM layer can be seamlessly combined with any other known module that can be employed in ConvNets. In this context, we introduce the SLIM block. FIG. 3 section (a) depicts that the SLIM block represents a compact ensemble of SLIM layers interleaved with batch normalization layers for improved generalization capabilities. Section (a) in FIG. 3 illustrates an expansion of Slim Block 1 in Section (b) of FIG. 3. The SLIM-Net structure in Section (b) of FIG. 3 illustrates an example of an overall architecture of the SLIM-Net model.

Beside the SLIM layer formulation discussed, a depth-wise and a point-wise SLIM layer can be used. In the depth-wise SLIM layer, the summation along the channels a E c is no longer required, and the point-wise operation is carried out considering kernels having size of 1×1. In both the depth-wise and point-wise convolutions, the fundamental operator of the typical MAC is replaced with the similarity metric of this technology

While FIG. 3 illustrates an order for the SLIM layers, any order or types of similarity measure layers may be used to form a SLIM Block. Having a variety of different SLIM layers can also help in the training operations because various outputs types can be used to better train the weights in a SLIM layer. In addition, different types of SLIM layers can increase the degree of freedom when designing and training a new model. For instance, there may be cases where having a point-wise separable layer drastically improves the overall performance of a given model. Therefore, having the possibility of specifying different primitives/structures within a SLIM layer can improve the adaptability and performance of SLIM-Nets to a variety of different problems. In another example, each SLIM block in FIG. 3 section (a) may be a 3×3 kernel with a similarity metric operation. Similarly, only a point-wise filter or depth-wise filter may be used as one or more SLIM layers in a SLIM block. In yet another example, the first two layers in a SLIM block may be a 3×3 kernel and the last layer may be a point-wise block. Any arrangement of the similarity measures in SLIM layers of a block may be used.

An example of the technology may be further described here. The performance of the SLIM-based approach compared to other models can be considered. An experimental setup of the technology may be compared to other models too.

This example SLIM-Net model may be composed of three SLIM blocks (illustrated in FIG. 3) followed by a global average pooling layer, two fully connected layers with a ReLU activation, and a final fully connected layer with a Softmax activation. The Softmax function may be used as the last activation function of the ConvNet to normalize the output of a network to a probability distribution over predicted output classes. All SLIM layers, besides the point-wise one, may have kernel sizes of 3×3 X where ri is the number of channels coming from the upstream layer. The overall architecture of the model, including the shape at the output of each SLIM block (dimensions indicated close to the arrows in FIG. 3), is illustrated in FIG. 3 section (b). For the global average pooling and fully connected layers, output shapes are reported in parentheses, below the name of the layer itself. The number of neurons for the last layer, however, may depend on the classes available in the dataset (e.g., 10 for CIFAR-10, 100 for CIFAR-100). The code for the model may use Python and the Tensorflow's Keras API, in one example. In particular, the definition of the example SLIM layer, being inherited from the default Keras' Layer class, can be seamlessly combined in any model definition, and thus trained with existing Tensorflow's built-in back-propagation methods.

For the sake of comparison, the following models are selected as baselines: VGG-16, DenseNet-121, MobileNetV1, and ResNet-50. All these models may be downloaded from the Tensorflow model library and their structure may be adapted to accept 32×32×3 input images. Furthermore, the models, including the aforementioned SLIM-Net, can be trained on the same datasets using the same pre-processing methodology, as described later.

### Adopted Open-Source Datasets

Both CIFAR-10 and CIFAR-100 datasets may be employed for evaluating the performance of the models. While both are composed of 60k 32×32 RGB images, the real differentiation lies in how many classes those images are assigned to. CIFAR-10 has 6k images for each of its 10 classes, whereas CIFAR-100 has only 600 images for each class, with a total of 100 classes. In order to improve the generalization capabilities of the models, images can be augmented via rotation, and vertical and horizontal shift operations. This pre-processing phase may also carried out via Tensorflow's built-in routines for data manipulation.

### Performance Evaluation

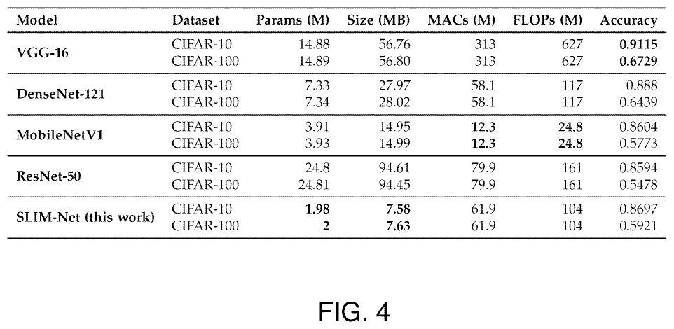

The table in FIG. 4 reports the obtained results for compared ConvNets, where the columns Params, Size, MACs, and FLOPs represent the number of total parameters (in millions), the total size of the models (in MB), and the total number of MACs and floating-point operations (in millions) for each model, respectively. Moreover, the last column Accuracy reports the Top-1 validation accuracy obtained by a given model on the indicated dataset. FIG. 4 illustrates a summary of the obtained results. Numbers in bold represent the best solution, column-wise.

As the numbers suggest, this technology (e.g., SLIM-Net) achieves the smallest memory footprint. If we consider VGG-16, namely, the most accurate model on CIFAR-10 with a 0.91 accuracy, this technology only has an accuracy degradation against VGG-15 of about 5%. However, the example SLIM-Net requires a mere 1.98 million parameters, instead of the almost 15 million required by VGG-16, thus marking a substantial 7.5X smaller model size. This example of the present technology shows a predictive performance on-par with another lightweight and hardware-friendly model, i.e., MobileNetV1. Nonetheless, this technology is capable of matching the performance of MobileNetV1, (i.e., both achieve around 0.6 accuracy) but the present technology uses almost half of the parameters as the MobileNetV1. On the other hand, when considering the computational complexity, SLIM-Net is less efficient than MobileNetV1. This is due to the higher complexity involved in each SLIM layer, which leverages a higher number of FLOPs to generate a single intermediate result. In contrast, more traditional, and thus less hardware-friendly, models like DenseNet-121 and ResNet-50 show 11% and 35% higher FLOPs than SLIM-Net, respectively. However, such a higher computational power does not translate into higher resource efficiency, since our solution substantially aligns with the accuracy of both DenseNet-121 and ResNet-50 on CIFAR-10, but with a model size that is 3.6X and 12.4X smaller, respectively.

To re-iterate and summarize, this technology provides a similarity-aware convolutional-like layer for deep neural networks. By leveraging a more meaningful operator (i.e., a similarity metric operator), which better correlates input feature maps to learnable weights, the SLIM layer enables the creation of rather compact deep learning models that are nonetheless able to match or exceed the performance of state-of-the-art ConvNets.

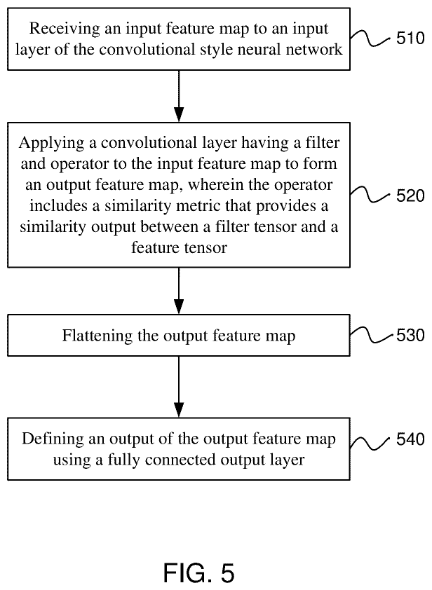

FIG. 5 illustrates a method of processing (e.g., with classification or regression output) using a convolutional style neural network. The method may include the operation of receiving an input feature map to an input layer of the convolutional style neural network, as in block 510. The input feature map may represent an image or other data that can be classified.

A convolutional layer may be applied to the input feature map using an operator and a filter to form an output feature map, as in block 520. The operator may include a similarity metric that provides a similarity output between a filter tensor from the filter and a feature tensor from the input feature map. The similarity output may be stored in the output feature map for each filter tensor and feature tensor pair. The similarity metric may determine a distance metric between the filter tensor from the filter and the feature tensor from the input feature map. In addition, the similarity metric can produce an output which approximates an activation function. Examples of a similarity metric may be at least one of: an L-2 norm of the feature tensor of the input feature map and the filter tensor, a modulo squared of the feature tensor and filter tensor that determines a distance metric between the feature tensor and the filter tensor defined between [−1, +1], a Cosine similarity, an Arccosine similarity, the similarity metric of Equation 3 in this disclosure, or a similarity metric computable between n-dimensional tensors. Furthermore, any similarity metric can be used as the operator which provides a similarity measure or distance measure and a non-linear output (e.g., similar to an activation function).

Using the similarity metric provides a more meaningful correlation between the inputs and the weights in the kernel. The similarity measure can provide more information because the operations can correlate the trained kernels (or filters) to the input images by determining a known distance metric between tensors in the kernels and input images. The use of a similarity measure or distance metric is valuable because the operator can provide output based on the similarity between the kernel and input image, which provides a more meaningful feature map. In order to recognize images, it is helpful to have the output parameters or weights from the similarity operation express similarity with one or more images that the kernel was trained on. The more similar the filter and input image are, the more likely the input image sample being received is relevant. Images with higher similarity measures are more likely to be classified correctly.

In past ConvNet models, two tensors (e.g., vectors) might be identified from the filter and from the input image, respectively. If a MAC and RELU operation are performed on these two tensors (e.g., vectors), these MAC and RELU operations have no real relation to how far apart the tensors (e.g., vectors) are or how similar the tensors (e.g., vectors) are. If a similarity measure is performed between two vectors, then the output can represent how far apart the vectors are (e.g., how similar they are). Assuming that prior training samples similar to the input image have been used to shape the kernel, then this technology can be compared to applying a point wise difference between the kernel and the input image to measure a distance between the kernel and input images. This point wise difference operation can be applied to the entire image and the kernel that is shaped by training images in order to enable classification of an input image or sample. More specifically, the output feature map may represent how far away the input image is from the filter on a per tensor basis (e.g., a per pixel basis). Then a classification or regression can be performed using these similarity values stored in the output feature map. When the filter and the image are closer together, better features, activations, and classifications may be generated.

The use of Equation (3) as a similarity measure can be compared to measuring distance (e.g. providing a similarity based on a direction and magnitude). Similarity measures that provide outputs range from [−1, +1] tend to provide the better classification results. Similarity outputs near −1 mean that two tensors are similar in the negative domain, and similarity outputs near+1 mean the tensors being used in the similarity measure are likely similar in the positive domain. Output values near zero mean the tensors (e.g., vectors) are substantially different.

Activation functions have been used in ConvNets to provide some desired non-linear output. Equation 3 and other similarity outputs may provide non-linearity built into the model. The activation function of the similarity measure may be embedded into the operator for the layer (i.e., into the similarity measure itself). The activation aspects of the similarity measure(s) can provide built in meaning, as discussed earlier. A MAC operator, as used in past models, does not have specific meaning. A separate activation function in prior ConvNets can provide some meaningful approximation of the MAC operation but this activation will have no inherent meaning.

The similarity function can be a diverging function. The middle of the function at zero represents a total difference between two tensors. Most feature maps will be zero or sparse. A zero may mean there is a non-activation when an input tensor (e.g., a pixel) is zero. Preferably the range of the output of a similarity measure will be in the range of [−1, 1], [0, 1] or [−1 to 0] because usually such output values provide information. The output results are better with a range of [−1, 1] because the negative portion of the results are maintained. Otherwise, the accuracy of the output may degrade quickly without the negative portion of the results.

In another configuration, the filter may be applied using the similarity metric by using a depth-wise filter. In yet another configuration, the filter may be applied using the similarity metric in a pointwise (1×1) filter. A further configuration may be a depth-wise separable filter. This depth-wise separable filter may be a convolution that is obtained by having a depth-wise layer applied first followed by a point-wise layer application. A mixture of layers using the operators with the similarity metrics may be used, including one or more of: a depth-wise filter, a point-wise filter or a depth-wise separable filter mode. A batch normalization may be applied after the convolution layer each time the convolution kernel is applied or just once after any convolution layers that are desired have been applied.

Another operation may be flattening the output feature map, as in block 530. One example operation for flattening the output map may be applying global average pooling to the output feature map. Flattening can be an operation that transforms 3-D (dimensional) feature maps coming from the last convolution or pooling layer into a 1-D tensor. While one example of the flattening functionality may be a Global Average Pooling layer, any other type of tensor dimensionality transformation may be used. Flattening as a transformation is typically used in CNN or CNN-derived models. Thus, the output feature map may be flattened either through a well-known flattening layer or any other type of layer that is able to project multi-dimensional output feature maps into a 1-dimensional tensor.

A further operation may be defining an output (e.g., a classification) for the output feature map using a fully connected output layer, as in block 540. Where the output is a classification layer, the classification layer can fire according to the class(es) the fully connected output layer(s) has been trained to identify. The similarity weights may activate the neurons that match that appropriate class when the input image is similar to the training the neural network previously received. Alternatively, a regression operation may be used in the place of the classification. Both a classification and regression are supervised learning constructions that can be trained using examples and both receive a plurality of inputs and provide one or more outputs. In terms of classification model design, the last fully connected output layer may consist of neurons having a softmax activation. A softmax is a normalization function that translates the excitatory states of output neurons into probabilities. For example, if there are 10 output neurons, like in the CIFAR-10 example, the sum of all output neurons' probabilities may add up to 1, where the neuron associated to the predicted label/class has the highest probability among all. In regression tasks, output neurons may have a linear activation function and their excitatory states may represent the number desired to be predicted (multiple neurons can be used for multiple concurrent predictions of different values). The same overall model can be used to solve a classification or a regression task by changing the activation function of the neurons in the last fully connected layer.

The output feature map may be three dimensional. This is because output feature map generated by a single filter is two-dimensional (2D). However, the final output feature map may be three-dimensional (3D), since any ConvNet layer can have multiple filters.

To summarize, this technology may reduce the complexity of neural networks and more specifically convolutional style neural networks and enable them to be better used in storage constrained devices.

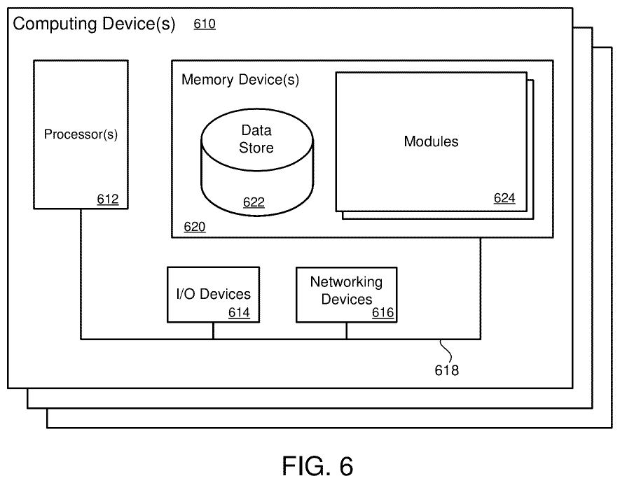

FIG. 6 illustrates a computing device 610 which may execute the foregoing subsystems of this technology. The computing device 610 and the components of the computing device 610 described herein may correspond to the servers and/or client devices described above. The computing device 610 is illustrated on which a high-level example of the technology may be executed. The computing device 610 may include one or more processors 612 that are in communication with memory devices 620. The computing device may include a local communication interface 618 for the components in the computing device. For example, the local communication interface may be a local data bus and/or any related address or control busses as may be desired.

The memory device 620 may contain modules 624 that are executable by the processor(s) 612 and data for the modules 624. For example, the memory device 620 may include an inflight interactive system module, an offerings subsystem module, a passenger profile subsystem module, and other modules. The modules 624 may execute the functions described earlier. A data store 622 may also be located in the memory device 620 for storing data related to the modules 624 and other applications along with an operating system that is executable by the processor(s) 612.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device is a display screen that is available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor 612. The term “executable” may mean a program file that is in a form that may be executed by a processor 612. For example, a program in a higher-level language may be compiled into machine code in a format that may be loaded into a random-access portion of the memory device 620 and executed by the processor 612, or source code may be loaded by another executable program and interpreted to generate instructions in a random-access portion of the memory to be executed by a processor. The executable program may be stored in any portion or component of the memory device 620. For example, the memory device 620 may be random access memory (RAM), read only memory (ROM), flash memory, a solid-state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method, comprising:
receiving an input feature map to an input layer of a convolutional style neural network;
applying a convolutional layer having a filter and operator to the input feature map to form an output feature map, wherein the operator includes a similarity metric that provides a similarity output between a filter tensor from the filter and a feature tensor from the input feature map;
flattening the output feature map; and
defining an output for the output feature map using a fully connected output layer.

2. The method as in claim 1, wherein the similarity metric determines a distance metric between the filter tensor from the filter and the feature tensor from the input feature map.

3. The method as in claim 1, wherein the similarity metric includes at least one of:
a L-2 norm of the feature tensor of the input feature map and the filter tensor,
a modulo squared of the feature tensor and filter tensor that determines a distance
metric between the feature tensor and the filter tensor defined between l-1, +11,
a Cosine similarity, or
a similarity metric computable between n-dimensional tensors.

4. The method as in claim 1, wherein the input feature map represents an image.

5. The method as in claim 1, further comprising applying the filter using the similarity metric by using a depth-wise filter.

6. The method as in claim 1, further comprising applying the filter using the similarity metric in a pointwise (1×1) filter.

7. The method as in claim 1, further comprising applying a batch normalization after the convolution layer.

8. The method as in claim 1, wherein the similarity metric produces output which approximates an activation function.

9. The method as in claim 1, wherein the output feature map is three dimensional.

10. The method as in claim 1, wherein flattening the output feature map further comprises applying global average pooling to the output feature map.

11. A system for classification using a convolutional style neural network, comprising:
at least one processor;
at least one memory device including a data store to store a plurality of data and
instructions that, when executed, cause the system and processor to:
receiving an input feature map to an input layer of the convolutional style neural network;
applying a convolutional layer having a filter and operator to the input feature map to form an output feature map, wherein the operator includes a similarity metric that provides a similarity output between a filter tensor from the filter and a feature tensor from the input feature map;
applying global average pooling to the output feature map; and
defining a classification of the output feature map using a fully connected output layer or defining an output of a regression operation.

12. The system as in claim 11, wherein the similarity metric includes at least one of:
a L-2 norm of the feature tensor of the input feature map and the filter tensor,
a modulo squared of the feature tensor and filter tensor that determines a distance metric between the feature tensor and the filter tensor defined between l-1, +11,
a Cosine similarity, or
a similarity metric computable between n-dimensional tensors.

13. The system as in claim 10, wherein the input feature map represents an image.

14. The system as in claim 10, further comprising applying the convolution layer with the similarity metric by using a depth-wise filter mode.

15. The system as in claim 10, further comprising applying the convolution layer with the similarity metric in pointwise (1×1) filter operation.

16. The system as in claim 10, further comprising applying the convolution layer with the similarity metric using a depth-wise separable filter mode.

17. A non-transitory machine readable storage medium including instructions embodied thereon for classification using a convolutional style neural network, wherein the instructions, when executed by at least one processor:
receiving an input feature map to an input layer of the convolutional style neural network;
applying a convolutional layer having a filter and operator to the input feature map to form an output feature map, wherein the operator includes a similarity metric that provides a similarity output between a filter tensor from the filter and a feature tensor from the input feature map;
applying global average pooling to the output feature map; and
indicating a classification of the output feature map using a fully connected output layer or defining an output of a regression operation.

18. The non-transitory machine readable storage medium as in claim 16, wherein the similarity metric includes at least one of:
a L-2 norm of the feature tensor of the input feature map and the filter tensor,
a modulo squared of the feature tensor and filter tensor that determines a distance metric between the feature tensor and the filter tensor defined between l-1, +11, or
a Cosine similarity.

19. The non-transitory machine readable storage medium as in claim 16, further comprising applying the filter with the similarity metric by using a depth-wise filter operation.

20. The non-transitory machine readable storage medium as in claim 16, further comprising applying the filter with the similarity metric in pointwise (1×1) filter operation.
